(19) United States
(12) Patent Application Publication
(10) Pub. No.: US 2017/0206802 A1
(43) Pub. Date: Jul. 20, 2017

(54) TOSSING TOY TO DEVELOP EYE-HAND COORDINATION

(71) Applicant: Christie McRae KIRMSE, Napa, CA (US)

(72) Inventor: Christie McRae KIRMSE, Napa, CA (US)

(21) Appl. No.: 15/381,786

(22) Filed: Dec. 16, 2016

Related U.S. Application Data
(60) Provisional application No. 62/388,096, filed on Jan. 15, 2016.

(51) Int. Cl. G09B 19/00; A63H 33/18

(52) U.S. Cl. CPC G09B 19/003; A63H 33/18

(57) ABSTRACT

A tossing toy includes a core, and one or more tendrils attached to the core, each of the one or more tendrils being extendable, each tendril changing orientation to spread away from the core when the tendril is extended, such that when the toy is accelerated in a direction of travel, each tendril spreads away from the core at an angle to the toy's direction of travel.

### CROSS-REFERENCE TO RELATED APPLICATIONS

This application claims priority from Provisional Application No. 62/388,096, filed on Jan. 15, 2016 in the United States Patent and Trademark Office, the disclosure of which is incorporated herein in its entirety by reference.

### BACKGROUND OF THE INVENTIVE CONCEPT

Field of the Invention

The description that follows relates generally to articles, devices and methods created to nurture eye-hand coordination. The primary objective is to train subjects including children and adults challenged by underdeveloped, degraded or impaired coordination capabilities. The invention “field” is two-fold in the sense that a target user population may include, for example, trainers or coaches tasked with engendering or perfecting eye-hand coordination, as well as children or adults simply engaging in “catch” as a form of indoor or outdoor play and/or self-development while confident that the thrown object will not impart damage to themselves or their surroundings.

Background

Most toddlers love to catch an object tossed their way, but their motor skills typically are not sufficiently developed or refined to visually track the object, mentally anticipate a possible interception point, and mentally direct movement of their hand(s) to that precise point where the “catch” is achieved. Other than repetitively “playing catch” there is little a parent, teacher or physical education trainer can do to help that child to gain proficiency. The pervasive opinion is that the act of “catching” a moving object is perfected only by doing.

To succeed, a user's (“training subject's”) act of viewing an approaching object and successfully grasping it in flight requires a complex and continuously practiced eye-brain-hand collaboration. This particular complex collaboration process obviously underlies and fosters a vast range of other physiological activities. In every instance, progress is incremental over a period of years, and typically achieved at different times for each individual trained subject.

Researchers are reporting that eye hand coordination, or EHC, is a gradually devolving or diminishing physical skill with each generation. More directly stated, children's acumen with respect to toss & catch games is on the decline. Eroding EHC skills most likely reflect a decline in action oriented playground exercises in favor of growing digital focus on small keyboards. Accordingly, a simple tool for use by children in early development of EHC is required to reverse this trend. Such a tool could also apply equally to disabled or otherwise challenged adults.

Those heralded as great athletes surely are blessed with a certain measure of “natural” ability. Still, and no different from the rest of us, every athlete's success in effectively developing critically important eye-hand coordination (EHC) skills requires early and constant practice. Unlike other physical attributes such as speed, dexterity, strength, stamina, and endurance, developing exceptional EHC demands complex motor/mental/vision collaboration is achieved only through considerable and repetitive practice.

The earlier EHC developmental practice begins, the better, and for everyone, not just budding athletes. This is because EHC is constantly called into play in every respect of a person's daily life. For a variety of reasons, however, EHC skills are not easily mastered and according to authoritative resources an individual's EHC deficiency is either misdiagnosed or ignored.

Internet-based resource Therapy Street for Kids (web address: therapystreetforkids.com) asserts that visual motor coordination problems in children are not discovered until a child is in elementary school. The first sign of problems may become apparent when a child struggles when tasked to write, draw simple pictures or apply classroom tools. Sometimes, such problems are erroneously associated with eyesight acuity issues, where visual acuity and visual perception may, in fact, be intact.

According to the Therapy Street resource, other misconceptions erroneously suggest a child is challenged by physical shortcomings in motor control or dexterity. Increasingly, educational experts are concluding the challenges are actually associated with the complex mechanism that enables the visual and motor systems to communicate and cooperate. The Therapy Street author recommends, among other things, practice in throwing large and small balls; larger balls for younger children and smaller for older children.

Despite a wealth of research about the nature and nuances of EHC, how best to teach toward enhanced EHC remains a challenge. Most experts agree that developmental practice generally benefits from quality instruction, thus turning increased focus on developing effective physical education (more popularly known as P.E.) instruction.

Global efforts are being undertaken to perfect teaching of EHC. For example, Yusmawati (see web-based: “Yusmawati—Asian Social Culture” March 2014) explores different methods of teaching EHC. Specifically, these methods involve (a) guided teaching and (b) play teaching. In the Yusmawati study, these methods and the effects caused thereby are assessed with respect to kinesthetic outcomes of throwing and catching a ball. Undertaken in East Jakarta, the assessments involved 149 third grade students in East Jakarta.

Yusmawati notes that one aspect of education constantly developed through this research is the learning process itself—noting the need for a universal theory in teaching that is focused on learning as an aspect of human behavior that stands alone. Physical education, as a component of overall education has been recognized by many. In practice, however, the teaching of physical education has not been as effective as expected. Yusmawati notes that, according to Mark Guthrie (2008), the skill of throw and catch has become less developed among children and will remain so if the shortcoming in performance is not addressed.

Guthrie goes on to say that physical educators are motivated to nurture such skills and that throw and catch abilities can be nurtured through development of effective teaching approaches.

In this context, Yusmawati further notes that Dauer and Pangraz (1992) explain that catching a ball is a skill commonly called upon in a variety of activities and should be trained with a different object, in different opportunities and challenges. Basic motion of the skills in throwing and catching a ball includes manipulative skill, viz. the ability to move or reposition heavy objects from one position to another (H. Abdul Kadir Ateng, 1992). According to Johnson and Nelson (2005), kinesthetic skill is the ability to move the body parts or the whole body in performing muscle movements.

A sampling of available global patent literature offers a number of “toss and catch” innovations that present a variety of ball design embodiments to enhance ball flight performance. To the extent permitted under current Rules of Practice (37 CFR), the following patent publications are, by reference thereto, incorporated herein in their entirety and for all purposes.

In published international patent application WO/1991/001164A1, inventor Arlan Paranto of Eatonville, Wash. describes a novelty ball asserted as particularly useful for teaching motor skills to children, such as throwing, catching and juggling, since (when in the air) the novelty balls appear considerably larger than their actual diameter. More specifically, the novelty ball includes a multiplicity of extending flexible whisker-like protrusions. These “whiskers,” however, are considerably different in configuration and extent than the Tossing Toy described in detail infra.

Rather than elongated tendrils extending considerably outwardly from a core (as will be described in detail herebelow) the whiskers on the Paranto ball are described as generally within the range of about 0.5 to 2.5 times the diameter of the ball. Whiskers should have some drape. They should not hang loosely but neither should they be stiff like bristles. Paranto's patent application suggests materials of construction may vary and notes that, for a small ball, sponge rubber has been found to be very satisfactory. He proposes very small diameter surgical rubber tubing for the whiskers.

As an example, a Paranto ball about 65 mm in diameter may have about 14 to 20 whiskers. For a larger ball the size of a soccer ball or basketball the whiskers (20) may be formed on a basal patches or strips (22, 26, 30, 34) that are adhesively or otherwise bonded to the surface of the ball (16). The balls when thrown will travel straight but roll to a stop very rapidly due to the whisker action. This application resulted in the grant of U.S. Pat. No. 4,149,723.

In U.S. Pat. No. 3,759,518, J. Mroz introduces a unitary toy to be repeatedly kicked to keep the toy in play and away from play-ending ground contact. The novel toy has a plurality of flexible strands disposed in a circular pattern with their outer ends substantially coterminous, and their inner ends tightly bunched between two parts of an elastomer kicking center. The kicking center is weighted to provide desired flight of the toy during repeated kicking, and the strands have inherent strength sufficient to maintain a pattern of circular plane without collapsing due to gravity.

Abner Simon of Sutherland, Va. was awarded U.S. Pat. No. 4,149,723 for a game apparatus which includes a projectile made of resilient foam material in the shape of an enlarged “jack” and a plurality of bats having soft impact areas which are used to strike the projectile so as to move the projectile between a pair of goal posts which are also preferably resilient. Generally, Simon's game apparatus is used to play a game which resembles field hockey, but may be played indoors or in a relatively confined outdoor area. By utilizing relatively “soft” bats and a relatively soft projectile, the chance of injury is reduced. Since the projectile has the shape of a “jack” it will often follow an irregular trajectory and will not roll far after hitting the ground.

Bruce Muchnick of Philadelphia, Pa. received U.S. Pat. No. 3,953,030 for a throw and catch toy for particular use by young children, mentally challenged or handicapped persons to enable the catching of an object thrown without requiring substantial muscular coordination or finger movement of the catching hand. The toy comprises the combination of an inflatable glove having a palm surface upon which plural patches of one component of VELCRO® are disposed and a ball having a surface upon which plural patches of the other component of VELCRO® are disposed. When the ball is thrown at the glove and makes contact with the palm side thereof the VELCRO® components on the ball and glove co-act to hold the ball on the glove without requiring the person wearing the glove to use his fingers to grasp the ball to hold it.

U.S. Pat. No. 4,657,253 was granted to Christopher Lerner of Washington, D.C. and Brian Kressin of Silver Spring, Md. This patent features a rubber-like ball having an elastic fabric attached thereto. The ball is thrown by grasping the fabric at a point distant from the ball and swinging the ball in a circular motion by the elastic fabric resulting in the ball and the elastic fabric becoming a catch-able projectile.

In U.S. Pat. No. 5,467,981, Elliot Rudell of Torrance, Calif. disclosed a football having an end appendage comprising at least one long, narrow strip of a flexible sheet material, e.g., cloth or flexible plastic, which functions as a tail when the ball is thrown or kicked and which provides directional stability for the football while in flight. When multiple strips are used which are formed of a rigidly flexible sheet such as MYLAR®, the appendage also functions as a sound generator.

When the Rudell football is thrown in a normal manner, the tail extends backwards, providing a slight drag to cause the back tip of the ball to align itself with the front tip, thereby resulting in the straight and accurate flight of the ball. The appendage can be fixedly or removably attached to the football, and for this purpose, can be attached with attachment tabs formed of hook and loop materials, commonly known as VELCRO®.

### SUMMARY OF THE INVENTION

It is therefore a primary object of the present invention to provide a system and method which improves upon prior art toys and their related drawbacks as described above.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a tossing toy including a core, and one or more tendrils attached to the core, each of the one or more tendrils being extendable, each tendril changing orientation to spread away from the core when the tendril is extended, such that when the toy is accelerated in a direction of travel, each tendril spreads away from the core at an angle to the toy's direction of travel.

In an exemplary embodiment, each of the one or more tendrils is formed in a coil shape, each of the one or more tendrils is configured to uncoil as the tendril extends, and each of the one or more tendrils is configured to spread away from the core at the angle to the toy's direction of travel due to the uncoiling of the tendril.

In an exemplary embodiment, the one or more tendrils are detachable from the core.

In an exemplary embodiment, the core includes an envelope surrounding a fill material.

In an exemplary embodiment, the envelope comprises a plurality of panels joined together at a corresponding plurality of seams.

In an exemplary embodiment, each of the one or more tendrils is attached to the core at one of the plurality of seams.

In an exemplary embodiment, the core comprises a unitary body that is substantially homogenous in composition.

The foregoing and/or other features and utilities of the present general inventive concept may also be achieved by providing a tossing toy including a plurality of tendrils, each tendril including a distal end, and a proximate end, and a core formed by joining the proximate ends of the plurality of tendrils together. The plurality of tendrils are configured to extend when the core is accelerated in a direction of travel, each of the plurality of tendrils being configured to extend at an angle to the direction of travel.

The foregoing and/or other features and utilities of the present general inventive concept may also be achieved by providing a tossing toy including a core, and one or more tendrils attached to the core, each of the one or more tendrils being configured to spread away from the core due to air flow over the tendril while the toy travels through the air.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a side elevation view of an embodiment of the tossing toy at rest;

FIGS. 2-5 are additional side elevation views depicting the tossing toy progressively rotated toward the viewer, and displaying varied extension of depending tendril elements;

FIG. 6 illustrates an exemplary embodiment of the present general inventive concept;

FIG. 7 illustrates an exemplary embodiment of the present general inventive concept, in which flexible coil elements are conjoined or affixed at their proximate ends and individually extending outwardly therefrom to separated distal ends; and

FIGS. 8A and 8B illustrate exemplary embodiments of the present general inventive concept including coiled segments.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

It will be understood that although the terms “first” and “second” are used herein to describe various elements, these elements should not be limited by these terms. These terms are only used to distinguish one element from another element. Thus, a first element could be termed a second element, and similarly, a second element may be termed a first element without departing from the teachings of this disclosure.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description of the preferred embodiments. Thus, the terms used herein are defined based on the intended meaning of the terms together with the description throughout the specification.

Also, when a part “includes” or “comprises” an element, unless there is a particular description contrary thereto, the part can further include other elements, not excluding the other elements.

Hereinafter, one or more exemplary embodiments of the present general inventive concept will be described in detail with reference to the accompanying drawings.

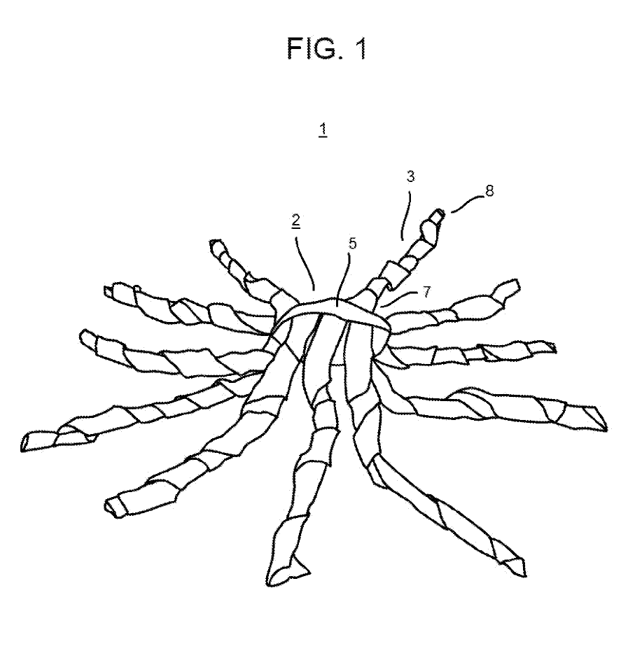

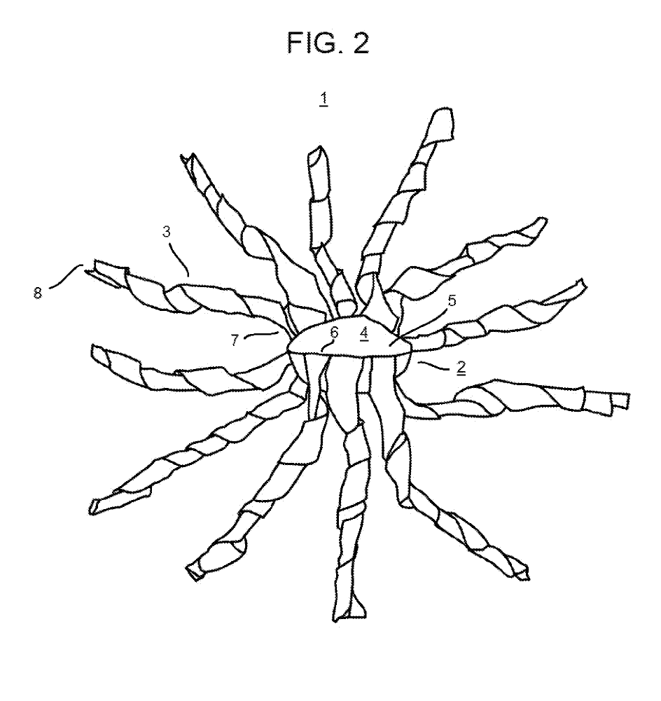

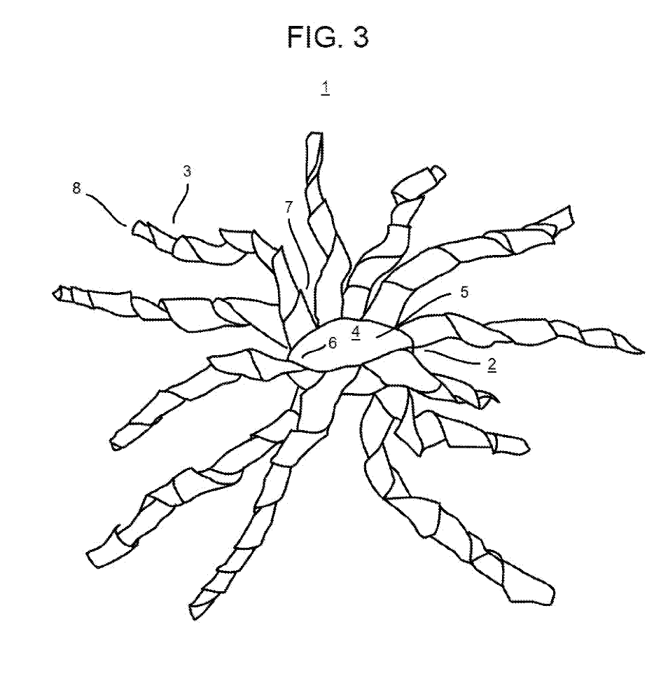

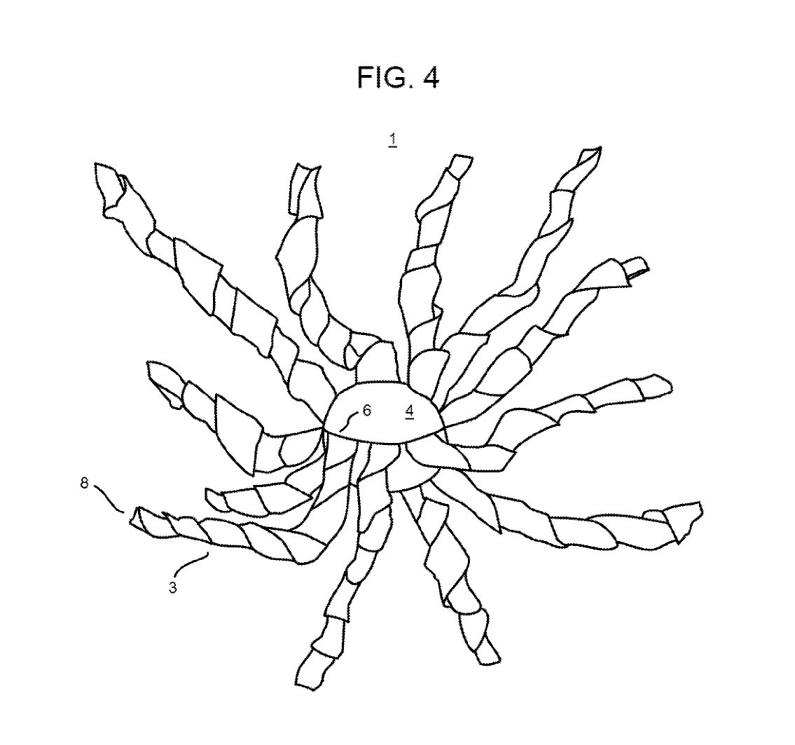

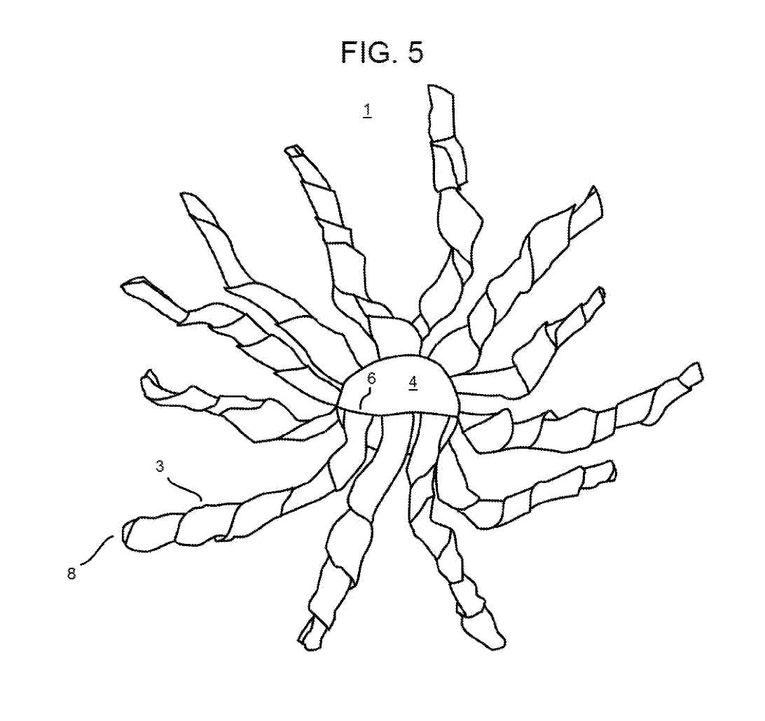

FIGS. 1-5 depict a training device in the form of a tossing toy 1 according to an exemplary embodiment of the present general inventive concept, with the view progressively rotated toward the viewer. FIGS. 1-5 depict an exemplary embodiment of such a toy 1 as it might appear at rest.

As illustrated for example in FIG. 1, toy 1 is generally defined as including a generally central mass or core 2, to which one or more discrete tendrils 3 are attached. In the exemplary embodiments illustrated in the drawings, the tendrils 3 may be stitched or sewn to the central mass or core 2. The tendrils 3 could be attached any of a variety of ways according to exemplary embodiments of the present general inventive concept, either permanently or temporarily. Core 2 and tendrils 3 may be fabricated of any of a variety of soft, pliable, flexible materials such as, for example, plastic, rubber, cotton, wool, or synthetics such as polyester, or combinations thereof. Exemplary embodiments of the present general inventive concept use polyester, since it readily accepts heat treatment to facilitate transformation of an otherwise flat tendril 3 into a loosely coiled configuration as illustrated in the drawings.

The central mass or core 2 may be generally spherical or “ball-like,” and in use most likely termed a “ball” by training subjects. However, the configuration is not to be considered as limited to a spherical or other fixed shape. The core 2 may have any shape which is reasonably aerodynamic, such that when the toy 1 is tossed in a given direction, the core 2 moves in this direction, as opposed to being deflected away by airflow over the core 2. According to the exemplary embodiments of the present general inventive concept, the core 2 may be generally spherical in shape, or as illustrated in FIGS. 1-5, the core 2 may be elongated, having the shape approximating, e.g., an egg, an American football, a 3-dimensional oval, etc.

The core 2 may include side stitched panels 5 stitched together at seams 6, such panels 5 being joined at a first and second end of the core 2 (similar to fabrication of elongated American footballs). In an exemplary embodiment of the present general inventive concept, there may be four panels 5, and a corresponding four seams 6.

The core 2 is preferably made of a relatively soft material, e.g., cotton, wool, or synthetics such as polyester, or combinations thereof. The core 2 preferably presents a shape, mass and weight suitable for hand-tossing, so as to perform its role as a training device to develop or enhance eye-hand coordination. Within reasonable limits, size or mass is unimportant as long as it satisfies a key objective of being easily grasped by small hands and adaptable to indoor use, without potential for damaging furniture, lamps, pictures, etc. or inflicting injury to users and instructors. Moreover, exemplary embodiments of the tossing toy 1 are preferably made of washable material, such that the tossing toy 1 may be kept clean and germ free.

According to an exemplary embodiment of the present general inventive concept, the core 2 may be constructed with a skin or soft shell of outer fabric envelope 4 subsequently or simultaneously “stuffed” with an inner core of fiber fill material (not illustrated). The fill material may comprise any of a variety of materials which are soft and lightweight, for example foam rubber. Optionally, still within the scope of the present general inventive concept, the core 2 can be fabricated wholly as a unitary body that is substantially homogenous in composition, rather than having an envelope 4 forming a discrete skin or shell around fill material.

Again, the tossing toy 1 must be of a size and shape easily grasped by hands small and large, thereby accommodating a wide variety of users or training subjects. The tossing toy 1 may be tossed as one would normally do in a toss/catch activity.

In the exemplary embodiment of the present general inventive concept illustrated in FIGS. 1-5, the fabric envelope 4 is defined by conjoined, multiple fabric panels 5. These panels 5 are suitably attached to one another via seams 6 to form the fabric envelope 4. The flexible tendrils 3 may be anchored or otherwise fixed to the envelope 4 at their respective proximate ends 7, and may extend generally unencumbered to their respective distal ends 8, also referred to herein as the “free” ends.

According to an exemplary embodiment of the present general inventive concept, the tendrils 3 may be generally identical in physical characteristics, particularly their length or outward extent from the core 2. In an alternative exemplary embodiment of the present general inventive concept, the tendrils 3 may have non-identical physical characteristics. For example, the tendrils 3 may have different colors, such that the resulting toy 1 is more readily perceivable by a human eye.

The tendrils 3 may be configured such that exerting force on them causes them to splay out, or move away from the core 2. This force may be, for example, the force exerted on the toy 1 to toss it through the air, or more specifically, the force exerted when the toy 1 is accelerated in a given direction of travel. Many shapes of tendrils 3 may be used according to exemplary embodiments of the present general inventive concept. Preferably, the tendrils 3 have a collapsed configuration when in their resting state (i.e. when the toy 1 is not being tossed), and an elongated configuration when the toy 1 is tossed. The tendrils 3 may be formed such that they naturally tend towards their collapsed state. As such, when the tendrils 3 are elongated by tossing the toy 1, the tendrils 3 resist this elongation. This resistance may push the tendrils 3 outward, away from the core 2, such that they extend at an angle to the toy 1's direction of travel. This angle may be, e.g., ninety degrees or less. In an alternative exemplary embodiment of the present general inventive concept, the tendrils 3 may have a natural curve that becomes more pronounced when they are elongated. In this exemplary embodiment, by tossing the toy 1 (accelerating the toy 1 in a given direction of travel), the tendrils 3 are elongated, expanding away from the core 2 at an angle to the toy 1's direction of travel.

According to an exemplary embodiment of the present general inventive concept, each of the tendrils 3 may be heat treated or similarly fabricated so as to be curled or loosely coiled into a generally spiral configuration. This formation gives the tendrils 3 a natural coiled shape, similar to a spring. With such coiled tendrils 3, when the toy 1 is accelerated, for example to toss the toy 1 through the air, the tendrils 3 are stretched along their length, such that they uncoil. The natural coiled shape of the tendrils 3 may push the tendrils 3 outward and away from the core 2 as the tendrils 3 extend, so that the tendrils 3 extend at an angle to the toy's 1 direction of travel.

In another exemplary embodiment of the present general inventive concept, the tendrils 3 may be formed such that airflow over the tendrils 3 causes the tendrils 3 to flail, such that they move erratically back and forth, thereby spreading out from the core 2 at an angle to the toy's 1 direction of travel.

When the tossing toy 1 is at rest, the tendrils 3 collectively depend or relax from the core by force of gravity. When projected or tossed from one user (e.g., a player in a game of catch) to another, the tossing toy core 2 follows the toy's 1 intended trajectory, while the tendrils 3 tend to separate, flail, and/or splay out from the core 2. By separating, flailing and/or spreading out, the tendrils 3 generate air resistance, which reduces the projectile speed of the toy 1, thereby making it easier to track visually and thereby catch. Furthermore, by separating, flailing, and/or spreading out, the tendrils 3 visibly broaden the toy's 1 overall profile depending on dimensions of the tendrils 3. If the tendrils 3 extend, this extension may also increase the toy's overall profile. According to an exemplary embodiment of the present general inventive concept, when the toy 1 is thrown, the toy's 1 profile may increase by a factor of about seven. In other words, the toy 1 visually expands to be a target up to seven times the width of the core 2.

According to an exemplary embodiment of the present general inventive concept, the tossing toy core 2 may have a breadth dimension of about four inches. Each of the tendrils 3 affixed to the core 2 and extending outwardly therefrom may have an extended length of, e.g., about twelve inches. Thus, a thrown tossing toy 1 with tendrils 3 fully spread laterally thereof (i.e., at a ninety-degree angle to the direction of travel of the toy 1) could present a visible breadth as much as twenty-eight inches at one or more points of flight, making the toy 1 visibly seven times the width of the core 2. Again, these dimensions are subject to considerable variation in actual execution and exemplary embodiments of the present general inventive concept.

Importantly, when in flight, the tossing toy 1, with its tendrils 3 both slowing the toy's velocity and increasing the toy's visual profile, the toy 1 presents a more easily acquired (“snagged”) target for visually tracking and catching by a toss-catch training subject (e.g., a child or challenged adult). This tossing toy 1 therefore measurably reduces the challenge of “playing catch” for those of any age with underdeveloped or somewhat impaired eye/hand coordination.

This configuration of the tossing toy 1 makes the act of catching easier, especially for toddlers just beginning to develop motor skills. Toddlers love playing with balls. This is a principal reason there are so many balls available in the marketplace. However, it is often difficult for a child or otherwise challenged individual to successful catch a prior art toy (e.g., a ball), since their motor skills are not yet sufficiently developed to master the act of tracking a toy in flight and successfully intercept and catch it by hand. This innovative tossing toy 1, which presents a larger, slower-moving target due to the tendrils 3, is significantly easier to catch and therefore helps build the training subject's coordination and self-esteem. The effect is to increase the play value for young children and improve coordination for the physically challenged of all ages.

In summary, the toss-catch toy 1 described herein makes it easier for toddlers and young children to master the challenge of catching, thus building self-esteem. Its soft construction does not pose a hurtful threat of injury or damage as compared to a hard or rigid construction, and the tendrils 3 make accuracy less of an issue when learning the fine motor skill of timing a catch. The toss-catch toy 1 builds user confidence as it makes the act of catching less challenging for young and/or physically challenged people.

According to an exemplary embodiment of the present general inventive concept, the materials of the core 2 and tendrils 3 may be machine washable in addition to being relatively soft. Parents will accordingly appreciate the toss-catch toy 1 as it is easily placed in a washer/dryer to maintain it clean and free of germ buildup. The toy 1 is safe to play with indoors as the soft construction will not knock over or otherwise damage household items such as lamps. Physical training practitioners (P.E. Ed. Professionals or caretakers) charged with providing rehabilitation experiences to Alzheimer's patients or other challenged adults will appreciate the gentle and non-threatening nature of this simple toss-catch toy 1.

According to an exemplary embodiment of the present general inventive concept, the tendrils 3 may be attached to the core 2 at the seams 6. In an exemplary embodiment, each seam 6 may secure three tendrils 3. As an example, if the training toy 1 is fabricated with 4 panels, the four adjoining seams 6 may collectively include as many as twelve tendrils 3. In an alternative exemplary embodiment of the present general inventive concept, a training toy 1 may include six panels 5 and seams 6 to which can be affixed a total of eighteen tendrils 3. It will be understood that more or fewer tendrils 3 may be attached at each seam 6 according to different exemplary embodiments of the present general inventive concept. For example, the exemplary embodiment of the present general inventive concept illustrated in FIG. 1 includes four seams 6 and eleven tendrils 3. Within reasonable and obvious limits, any combination of seams 6, panels 5, and tendrils 3 may be formulated. Altering the number and/or length of tendrils 3 introduced into play (or training exercise) can have advantages as will be explained infra.

The design and fabrication features of the training toy 1 serve both to alter its projected velocity and widen or narrow its effective profile in flight. This is due, of course, to the effect of air drag on the tendrils 3 and the tendency of each tendril 3 to spread apart, flail, and/or increase extension, outwardly away from the fabric envelope 4 during flight. The result is that an inexperienced or otherwise challenged receiver of tossed training toy 1 will have extra time to mentally “read” or gauge the arc, proximity, and velocity of the toy 1 as it approaches.

Due to the natural propensity for tendrils 3 to splay out as toy 1 is projected, thereby increasing the profile of the toy 1, the intended receiver (training subject) is more likely to move her/his hand to make a grasping connection at the receiving end of the toss. The intended receiver may grasp the toy 1 by the core 2 or any of the tendrils 3 to successfully catch the toy 1. Successfully snagging (catching) the toy 1 by any portion thereof brings emotional reinforcement as well as a learning experience.

Advantageously, the described toss-catch training toy 1 may be easily customized or modified as a subject's eye-hand coordination performance improves, somewhat similar to removing training wheels from a bicycle. This allows the toss-catch training toy 1 to be modified as dictated by the training subject's improved EHC prowess. Additionally, this allows a single toy 1 to be used with several different subjects having different EHC prowess, as the toy 1 may be modified according to each subject's individual ability.

According to an exemplary embodiment of the present general inventive concept, some or all tendrils 3 may be shortened in stages (for example, by snipping or clipping), thereby affording less drag and moderated spread during flight. According to another exemplary embodiment of the present general inventive concept, some of the tendrils 3 may be tied together to modify the projectile characteristics of the toy 1. This exemplary embodiment allows tendrils 3 to be untied as well, thereby allowing the effect the tendrils 3 have on the projectile characteristics of the toy 1 to be modified more dynamically.

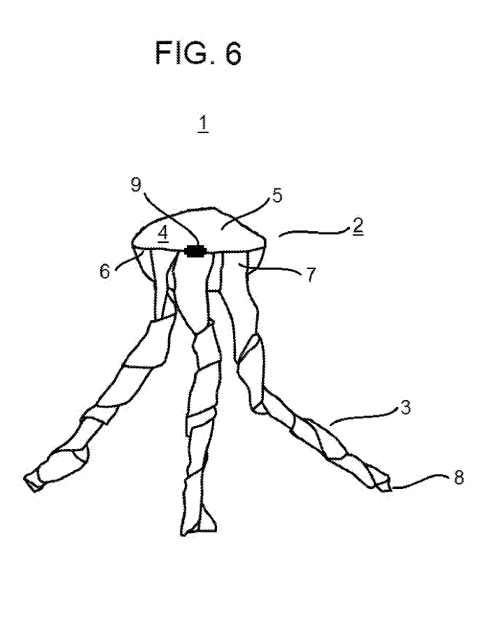

According to an exemplary embodiment of the present general inventive concept, one or more of the tendrils 3 may be removably attached to the core 2 by fasteners 9 (illustrated as a clip in FIG. 6). Fasteners 9 may comprise one or more of pins, clips, hook-and-loop fasteners such as VELCRO®, and the like. Each of the fasteners 9 is preferably strong enough to support the weight of the toy 1, such that if a user catches the toy 1 by a tendril 3, the tendril 3 remains attached to the core 2, thereby allowing the user to catch the toy 1 effectively.

Removable tendrils 3 enable the toy's performance to be altered by selectively adding or reducing tendrils 3 to the core 2. For example, FIG. 6 illustrates a toy 1 including only three tendrils 3, all other tendrils 3 having been removed. The toy 1 illustrated in FIG. 6 will have different flight characteristics than a toy 1 with more tendrils 3 attached. Similarly, different tendrils 3, for example tendrils 3 having different air drag or extension characteristics, may be substituted on a given core 2, to further adjust projectile characteristics of the toy 1. Naturally, the projectile characteristics of the toy 1 may be modified as required, for example if the training subject regresses in catch prowess, or if another training subject with different coordination wants to use the toy 1. For example, tendrils 3 may be made denser or longer by adding more tendrils 3 or replacing one type of tendril 3 with another type, for example longer tendrils 3 which generate more air resistance and therefore slow the flight of the toy 1. Ideally, as the toy toss/catch training gradually gains effectiveness, all tendrils 3 can be progressively removed to the point where only the ball-like core 2 remains in use.

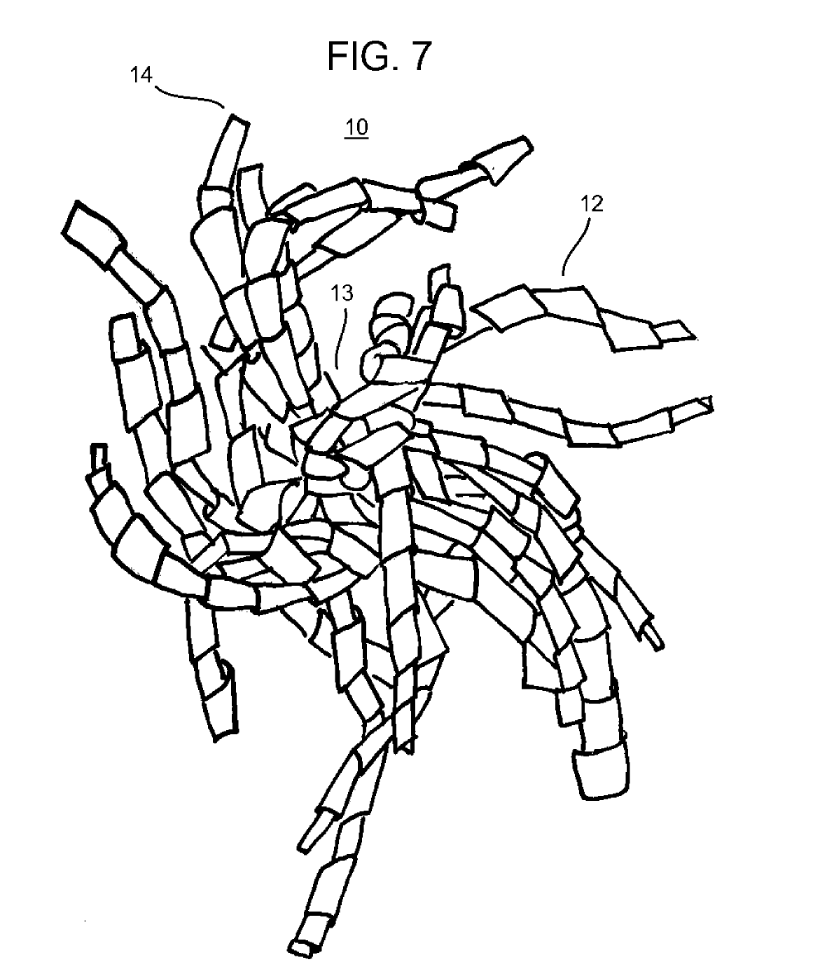

FIG. 7 illustrates an alternative embodiment of a toss/catch toy 10 wherein flexible, coiled tendrils 12 are generally centrally gathered rather than stitched to form a central core 2, so as to extend multi-directionally outwardly therefrom. In other words, the proximate ends 13 of the various tendrils 12 are joined together, thereby forming a central mass, functioning similarly to the core 2 described above, but without forming a core that would be distinct from the tendrils 12. The distal ends 14 of the tendrils 12 are still loose, such that the tendrils 12 can still separate, flail, and/or extend to splay out as the toy 10 is tossed. It will be understood that other aspects of the present general inventive concept, e.g., removable tendrils, described above with reference to FIGS. 1-6 may also be applied to the exemplary embodiment illustrated in FIG. 7.

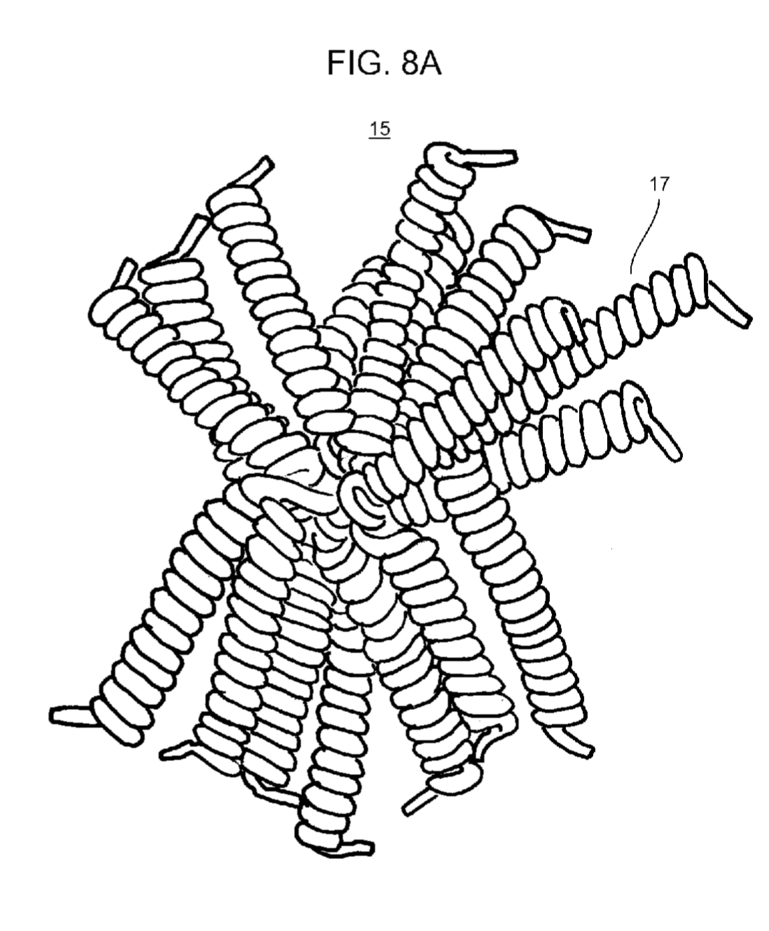

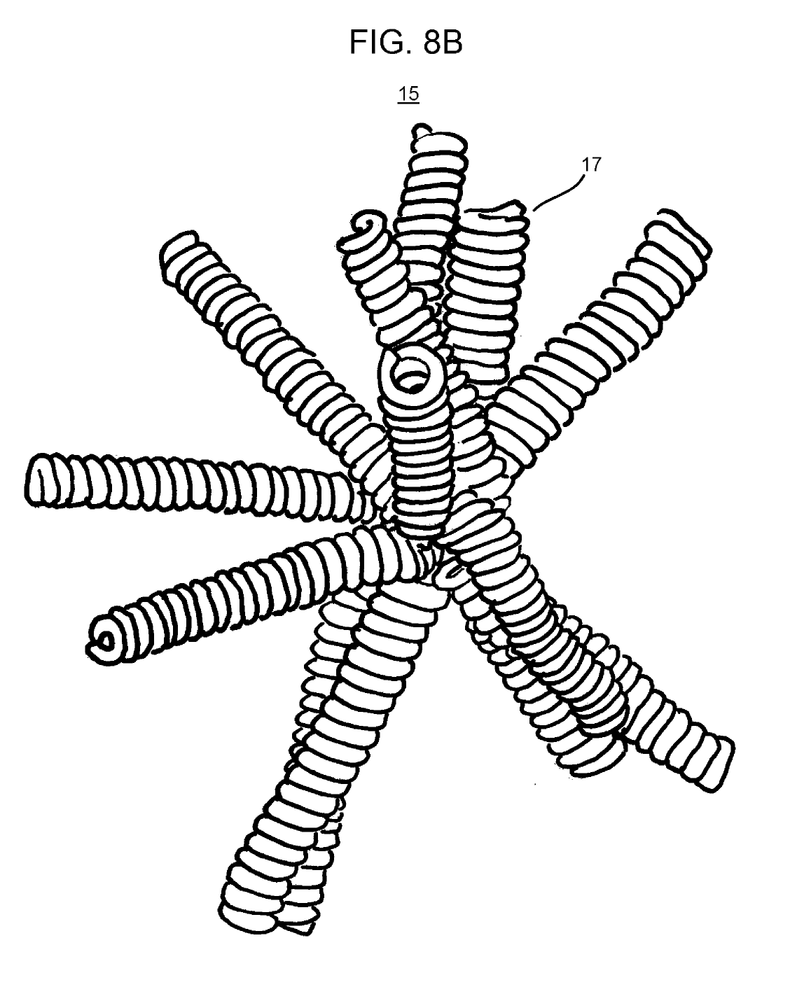

FIGS. 8A and 8B illustrate alternative exemplary embodiments of the toy 15, including coiled segments 17 splay outward. The segments 17 may be made of, for example, plastic or rubber. The segments 17 may be interconnected centrally, similar to the exemplary embodiment illustrated in FIG. 7, or alternatively they may be connected to a core 2 similar to the exemplary embodiment illustrated in FIG. 1. A toy 15 according to the exemplary embodiments illustrated in FIGS. 8A and 8B may be thrown and caught in much the same manner as the toy 1 described above, with similar outcomes discussed above. It will be understood that other aspects of the present general inventive concept, e.g., removable tendrils, as described above with reference to FIGS. 1-6, may also be applied to the exemplary embodiment illustrated in FIGS. 8A-8B.

Exemplary embodiments of the present general inventive concept provide a breadth of scope that includes the novel article itself, and all methods of making and using it. Any equivalent variations on the theme and methodology of accomplishing the same that are not described herein would be considered under the scope of the present general inventive concept.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims, and by their equivalents.

What is claimed is:

1. A tossing toy, comprising:
a core; and
one or more tendrils attached to the core, each of the one or more tendrils being extendable, each tendril changing orientation to spread away from the core when the tendril is extended, such that when the toy is accelerated in a direction of travel, each tendril spreads away from the core at an angle to the toy's direction of travel.

2. The tossing toy of claim 1, wherein:
each of the one or more tendrils is formed in a coil shape;
each of the one or more tendrils is configured to uncoil as the tendril extends; and
each of the one or more tendrils is configured to spread away from the core at the angle to the toy's direction of travel due to the uncoiling of the tendril.

3. The tossing toy of claim 1, wherein the one or more tendrils are detachable from the core.

4. The tossing toy of claim 1, wherein the core comprises an envelope surrounding a fill material.

5. The tossing toy of claim 4, wherein the envelope comprises a plurality of panels joined together at a corresponding plurality of seams.

6. The tossing toy of claim 5, wherein each of the one or more tendrils is attached to the core at one of the plurality of seams.

7. The tossing toy of claim 1, wherein the core comprises a unitary body that is substantially homogenous in composition.

8. A tossing toy, comprising:
a plurality of tendrils, each tendril comprising:
a distal end; and
a proximate end; and
a core formed by joining the proximate ends of the plurality of tendrils together,
wherein the plurality of tendrils are configured to extend when the core is accelerated in a direction of travel, each of the plurality of tendrils being configured to extend at an angle to the direction of travel.

9. A tossing toy, comprising:
a core; and
one or more tendrils attached to the core, each of the one or more tendrils being configured to spread away from the core due to air flow over the tendril while the toy travels through the air.
